(19) United States
(12) Patent Application Publication
(10) Pub. No.: US 2025/0304855 A1
(43) Pub. Date: Oct. 2, 2025

(54) PREPARATION METHOD OF CORE-SHELL QUANTUM DOTS

(71) Applicant: Tianjin University, Tianjin (CN)

(72) Inventors: Hongli Liu, Tianjin (CN); Yaxin Li, Tianjin (CN); Shirong Wang, Tianjin (CN); Xianggao Li, Tianjin (CN)

(21) Appl. No.: 18/930,922

(22) Filed: Oct. 29, 2024

(30) Foreign Application Priority Data
Apr. 2, 2024 (CN) 2024103941617

(51) Int. Cl. C09K 11/66; B82Y 20/00; B82Y 40/00

(52) U.S. Cl. CPC C09K 11/662; B82Y 20/00; B82Y 40/00

(57) ABSTRACT

A preparation method of core-shell quantum dots is provided. The method includes mixing lead source, cadmium source, oleic acid, oleylamine and organic solvent to dissolve the lead source and the cadmium source in the organic solvent and thereby obtain a first solution; adding cesium oleate solution into the first solution for a first reaction to thereby obtain a first reaction solution; and adding sulfur source into the first reaction solution for a second reaction to thereby obtain the core-shell quantum dots, wherein the core-shell quantum dots are perovskite core-shell quantum dots (Cd:CsPb(Br₁₋ₓClₓ)₃/CdS). The method simplifies simplifies a synthesis process of the perovskite core-shell quantum dots (Cd:CsPb(Br₁₋ₓClₓ)₃/CdS), and used raw materials are cheaper and easily available. The core-shell quantum dots prepared by the method have uniform size and excellent deep blue light emitting performance.

### CROSS-REFERENCE TO RELATED APPLICATION

This application claims priority to Chinese Patent Application No. 202410394161.7, filed on Apr. 2, 2024, which is herein incorporated by reference in its entirety.

### TECHNICAL FIELD

The disclosure relates to the technical field of the preparation of photoelectric materials, particularly to a preparation method of core-shell quantum dots.

### BACKGROUND

Perovskite quantum dots (PeQDs) have been widely regarded as the most promising materials in the next generation of lighting and display fields because of their excellent optical properties, such as an easily tunable band gap width, a narrower emission spectrum half-peak width, a higher fluorescence quantum yield, a stronger defect tolerance and a simpler preparation method. However, as an ionic semiconductor, the PeQDs are sensitive to the following conditions, such as water, oxygen, light, high-temperature and polar solvents. Under the above conditions, a crystal structure and a chemical composition of the PeQDs will change, and the optical properties will decay rapidly. Moreover, long-chain organic ligands of the PeQDs (such as oleic acid and oleylamine) are not firmly bonded to a surface of perovskite, but form a dynamic equilibrium of adsorption and desorption, so in a process of anti-solvent purification or long-term storage, the organic ligands are easy to fall off a surface of the quantum dots, leading to the agglomeration and decomposition of the PeQDs. In addition, due to characteristics of Cl vacancies, such as low formation energy and deep-level defects, the non-radiation recombination of blue-emitting Br/Cl mixed-halide perovskite is serious, and it is prone to halide ion migration, thereby facilitating the decomposition of perovskite. These problems seriously limit commercial application of the PeQDs. At present, it is considered to be an effective method to improve the stability of the PeQDs by coating the PeQDs with an inert shell material. Commonly used shell materials are SnO₂, TiO₂, Cs₄PbBr₆, metal sulfides and polymers. A large number of research results prove that perovskite core-shell quantum dots can not only improve the environmental stability of a perovskite core, but also can improve the fluorescence quantum yield, change carrier transport and inhibit ion exchange and migration.

Common amorphous SnO₂, TiO₂ and polymer shells are usually insulating, which is not conducive to the injection of carriers in an electroluminescent process, and usually form an aggregate of multiple PeQDs coated by one shell, and it is difficult to achieve accurate coating at a single particle level. When SnO₂ and TiO₂ shells are prepared by a sol-gel method, the PeQDs are required to be stirred in a water-containing system for a long time, as such water molecules in the water-containing system will erode a surface of the perovskite and thus luminous efficiency of the perovskite is reduced. The stability of a perovskite shell is poorer, and the perovskite shell is easy to undergo phase transformation, which leads to interfacial lattice strain and reduces the environmental stability and luminescent properties of the PeQDs. The growth of covalent metal sulfide shell with a wider band gap requires higher temperature and longer reaction time, which will lead to phase transition and even decomposition of the perovskite core at the higher temperature. Therefore, on the basis of avoiding damage to the perovskite core, it is still a great challenge for perovskite core-shell quantum dots to grow an inert shell with uniform thickness on a surface of the perovskite core to improve the environmental stability and luminescent properties of the PeQDs.

### SUMMARY

Based on the above, the disclosure provides a preparation method of core-shell quantum dots. The core-shell quantum dots are perovskite core-shell quantum dots (Cd:CsPb(Br₁₋ₓClₓ)₃/CdS). In the preparation method, cadmium bromide (CdBr₂) and cadmium chloride (CdCl₂) are used as cadmium source and sulfur-octadecene is used as cadmium sulfur source, as such, the high-temperature stability of a perovskite core is ensured, and the core-shell quantum dots are perovskite core-shell quantum dots (Cd:CsPb(Br₁₋ₓClₓ)₃/CdS) are prepared, where x represents a ratio of chlorine element (Cl) to halogen elements (i.e., Br and Cl) in the core-shell quantum dots, and x is in a range from 0 to 1. The lattice mismatch between perovskite and CdS is smaller, so the existence of CdS shell reduces the defect state density on a surface of the perovskite, improves the fluorescence quantum yield and prolongs the fluorescence lifetime, and makes perovskite core-shell quantum dots have excellent deep blue light emission performance.

In order to achieve the above objectives, the disclosure provides the following technical solutions.

In a first aspect, an embodiment of the disclosure provides a preparation method of core-shell quantum dots, which includes the following steps:
mixing lead source, cadmium source, oleic acid, oleylamine and organic solvent to dissolve the lead source and the cadmium source in the organic solvent and thereby obtain a first solution;
adding cesium oleate solution into the first solution for a first reaction to thereby obtain a first reaction solution; and
adding sulfur source into the first reaction solution for a second reaction to thereby obtain the core-shell quantum dots, wherein the core-shell quantum dots are perovskite core-shell quantum dots (Cd:CsPb(Br₁₋ₓClₓ)₃/CdS).

In an illustrated embodiment, the lead source is lead bromide (PbBr₂), the cadmium source is a mixture of cadmium bromide (CdBr₂) and cadmium chloride (CdCl₂), and a molar ratio of CdBr₂ to CdCl₂ is 1:(1.5-2).

In an illustrated embodiment, a molar ratio of the lead source to the cadmium source is 2:3; a volume ratio of the oleic acid to the oleylamine is 1:1, and a molar volume ratio of the lead source to the oleic acid is 0.2 millimoles (mmol):(1-1.5) milliliters (mL).

In an illustrated embodiment, a molar ratio of Cs⁺ in the cesium oleate solution to Pb²⁺ in the lead source is 0.28:1.

In an illustrated embodiment, a temperature of the second reaction is 155-165° C., and a period of the second reaction is 5-10 min.

In an illustrated embodiment, the sulfur source is a sulfur-octadecene solution, a concentration of the sulfur-octadecene solution is 0.4 mmol/mL, and a molar volume ratio of the lead source to the sulfur source is 2 mmol:5 mL.

In an illustrated embodiment, a preparation method of the sulfur-octadecene solution includes: mixing sulfur (S) and octadecene for a third reaction to thereby obtain the sulfur-octadecene solution.

In an illustrated embodiment, a temperature of the third reaction is 160° C., and a period of the third reaction is 1.2-2.5 h.

In a second aspect, an embodiment of the disclosure provides perovskite core-shell quantum dots (Cd:CsPb(Br₁₋ₓClₓ)₃/CdS), and the perovskite core-shell quantum dots are prepared by the preparation method described above.

In a third aspect, an embodiment of the disclosure provides an application method of the perovskite core-shell quantum dots (Cd:CsPb(Br₁₋ₓClₓ)₃/CdS) described above, and the application includes: applying the core-shell quantum dots in illumination or display.

The disclosure has at least the following technical effects.

The disclosure simplifies a synthesis process of the perovskite core-shell quantum dots (Cd:CsPb(Br₁₋ₓClₓ)₃/CdS), and used raw materials are cheaper and easily available. The core-shell quantum dots prepared by the method of the disclosure have uniform size and excellent deep blue light emitting performance.

### BRIEF DESCRIPTION OF DRAWINGS

In order to explain technical solutions of the embodiments of the disclosure or the technical solutions of the related art more clearly, drawings needed in the embodiments will be briefly introduced below. Apparently, the drawings described below are only some embodiments of the disclosure, and other drawings can be obtained according to these described drawings without creative work for ordinary people in the art.

FIG. 1A illustrates a transmission electron microscopy (TEM) image of core quantum dots prepared in an embodiment 1.

FIG. 1B illustrates a high resolution transmission electron microscope (HRTEM) image of the core quantum dots prepared in the embodiment 1.

FIG. 1C illustrates a TEM image of core-shell quantum dots prepared in an embodiment 2.

FIG. 1D illustrates an HRTEM image of the core-shell quantum dots prepared in the embodiment 2.

FIG. 1E illustrates a measurement result of a lattice spacing of the core quantum dots prepared in the embodiment 1.

FIG. 1F illustrates a measurement result of a lattice spacing of the core-shell quantum dots prepared in the embodiment 2.

FIG. 2 illustrates energy-dispersive x-ray (EDX) results of the core-shell quantum dots prepared in the embodiment 2.

FIG. 3 illustrates x-ray diffraction (XRD) characterization results of the core quantum dots prepared in the embodiment 1 and the core-shell quantum dots prepared in the embodiment 2.

FIG. 4 illustrates optical characterization results of the core quantum dots prepared in the embodiment 1 and the core-shell quantum dots prepared in the embodiment 2; where (a) illustrates an ultraviolet-visible absorption spectrum and a fluorescence spectrum, and (b) illustrates a time-resolved fluorescence spectrum.

### DETAILED DESCRIPTION OF EMBODIMENTS

Exemplary embodiments of the disclosure will now be described in detail, and this detailed description should not be considered as a limitation of the disclosure, but should be understood as a more detailed description of certain aspects, characteristics and embodiments of the disclosure.

It should be understood that the terminology described in the disclosure is only for describing specific embodiments and is not used to limit the disclosure. In addition, for a numerical range in the disclosure, it should be understood that each intermediate value between an upper limit and a lower limit of the numerical range is also specifically disclosed. Intermediate values within any stated value or stated range, as well as each of smaller ranges between any other stated value or intermediate values within the stated range are also included in the disclosure. Upper and lower limits of these smaller ranges can be independently included or excluded from the ranges.

Unless otherwise specified, all technical and scientific terms used herein have the same meaning as commonly understood by one of ordinary skill in the art to which this disclosure relates. Although the disclosure only describes the preferred methods and materials, any methods and materials similar or equivalent to those described herein can also be used in the practice or testing of the disclosure. All documents mentioned in this specification are incorporated by reference to disclose and describe methods and/or materials related to the documents. In case of conflict with any incorporated document, the contents of this specification shall prevail.

It is apparent to those skilled in the art that many improvements and changes can be made to the specific embodiments of the disclosure without departing from the scope or spirit of the disclosure. Other embodiments will be apparent to the skilled person from the description of the disclosure. The specification and the embodiments of that disclosure are merely exemplary.

The terms “including”, “comprising”, “having” and “containing” used herein are all open terms, which means including but not limited to.

The term “Room temperature” in the disclosure means 15-30° C. unless otherwise specified.

In a first aspect, an embodiment of the disclosure provides a preparation method of perovskite core-shell quantum dots (Cd:CsPb(Br₁₋ₓClₓ)₃/CdS), which includes:
mixing lead source, cadmium source, oleic acid, oleylamine and organic solvent to dissolve the lead source and the cadmium source in the organic solvent and thereby obtain a first solution;
adding cesium oleate solution into the first solution for a first reaction to thereby obtain a first reaction solution; and
adding sulfur source into the first reaction solution for a second reaction to thereby obtain the perovskite core-shell quantum dots (Cd:CsPb(Br₁₋ₓClₓ)₃/CdS).

In an illustrated embodiment, the lead source is lead bromide (PbBr₂), the cadmium source is a mixture of cadmium bromide (CdBr₂) and cadmium chloride (CdCl₂), and a molar ratio of CdBr₂ to CdCl₂ is 1:(1.5-2).

The reason why the molar ratio of CdBr₂ to CdCl₂ is limited to 1:(1.5-2) in the disclosure is that a peak value of a fluorescence spectrum will change when a ratio of Br and Cl in a system changes. When the molar ratio of CdBr₂ to CdCl₂ is in a range from 1:1.5 to 1:2, the fluorescence spectrum is in a range of deep blue light. Exceeding the above ratio range will lead to the fluorescence spectrum range exceeding the deep blue light range.

In the disclosure, CdBr₂ and CdCl₂ are used as the cadmium source, which can not only be used as precursors of a CdS shell, thereby simplifying a complicated injection process; but also be doped into a crystal lattice of perovskite (CsPb(Br₁₋ₓClₓ)₃), thereby improving the high-temperature stability of the perovskite. Therefore, the perovskite core-shell quantum dots do not undergo phase transformation or decomposition after long-time heating.

In an illustrated embodiment, a molar ratio of the lead source to the cadmium source is 2:3, a volume ratio of the oleic acid to the oleylamine is 1:1, and a molar volume ratio of the lead source to the oleic acid is 0.2 mmol:(1-1.5) mL.

The oleic acid and the oleylamine, as surface ligands, play a role in stabilizing the quantum dots and regulating the size and morphology of the quantum dots during a synthesis process of the PeQDs. The volume ratio of the oleic acid to the oleylamine is 1:1, which can ensure a shape of the generated quantum dots to be cubic. Too high volume ratio of the oleic acid to the oleylamine may lead to the change of the morphology of the quantum dots.

If the addition amount of the oleylamine and the oleic acid is too small, the solubility of metal salt (i.e., the lead source and the cadmium source) will decrease, so the disclosure limits the dosage of the oleylamine and the oleic acid to the above parameter range.

Too high or too low the molar ratio of lead (Pb) to cadmium (Cd) will lead to the change of the peak value of the fluorescence spectrum and decrease fluorescence quantum yield (PLQY). The lower molar ratio of Pb to Cd will cause serious lattice distortion, which will lead to the decrease of the PLQY and the deterioration of luminous performance. Therefore, the disclosure limits the molar ratio of the lead source to the cadmium source to 2:3.

In an illustrated embodiment, a temperature of the first reaction is 160° C.; a period of the first reaction is 5-10 seconds (s), more preferably 5 s; and a molar ratio of Cs⁺ in the cesium oleate solution to Pb²⁺ in the lead source is 0.28:1.

The reason why the temperature and the period of the first reaction are limited to the above parameters is that the crystallinity of the perovskite is the best when the molar ratio of Cs⁺ to Pb²⁺ is 0.28:1, too high or too low molar ration will lead to the deterioration of crystallinity of the perovskite and the formation of low-dimensional phases. The reaction condition of 160° C. can promote the rapid nucleation and growth of perovskite monomer and form quantum dots with uniform size, in constract, PeQDs grow slowly and insufficiently at a lower reaction temperature, resulting in a wider size distribution. After 5 s of the first reaction, the growth of PeQDs can be terminated by cooling in an ice water bath to avoid excessive growth.

In an illustrated embodiment of the disclosure, a temperature of the second reaction is 155-165° C., and a period of the second reaction is 5-10 min.

The reason why the temperature and the period of the second reaction are limited to the above parameters is that at the temperature of 160° C., the sulfur source will slowly generate reaction precursors, and thus avoid self-nucleation of CdS and promote epitaxial growth of CdS on a surface of the perovskite. Excessive temperature will produce a large number of sulfur precursors, which will promote the self-nucleation of CdS. If the period of the second reaction is too long, the perovskite will undergo phase transformation, resulting in interface lattice mismatch. If the period of the second reaction is too short, the CdS shell will be too thin and the PLQY will be reduced.

In an illustrated embodiment of the disclosure, the sulfur source is a sulfur-octadecene solution, a concentration of the sulfur-octadecene solution is 0.4 mmol/mL, and a molar volume ratio of the lead source to the sulfur source is 2 mmol:(5-7.5) mL.

The reasons why the concentration of the sulfur-octadecene solution and the molar volume ratio of the lead source to the sulfur source (that is, the mount of the sulfur-octadecene solution) are limited to the above-mentioned parameter ratios are as follows: the concentration of the sulfur-octadecene solution determines its reaction activity: too high concentration leads to too high activity and thereby CdS is prone to self-nucleation; too low concentration will lead to too low activity, and thereby CdS cannot be epitaxially grown on the surface of the quantum dots. The amount of the sulfur-octadecene determines a thickness of CdS shell. Too much sulfur-octadecene will lead to the generation of impurity PbS, and too little sulfur-octadecene will lead to an uneven coating of CdS shell on PeQDs.

In an illustrated embodiment of the disclosure, the preparation method of the sulfur-octadecene solution includes: mixing sulfur (S) and octadecene for a third reaction to thereby obtain the sulfur-octadecene solution.

In an illustrated embodiment of the disclosure, a temperature of the third reaction is 160° C., and a period of the third reaction is 1.2-2.5 h.

The reason for choosing the above temperature and period of the third reaction is that the heated sulfur-octadecene solution is a sulfur source with moderate reactivity, the perovskite core will not be eroded when the CdS is epitaxially growed on the surface of the perovskite, so the generated perovskite core-shell quantum dots are uniform in size and keep a cubic shape. The reason why the temperature and the period of the third reaction are limited to the above parameters is that the reaction activity of the sulfur-octadecene solution will be enhanced during a heating process of the sulfur-octadecene solution, and when the temperature is too low, it takes a longer time to generate the sulfur source with the same activity; and when the temperature is too high, the period needs to be reduced, and when a reaction speed is fast, so it is not easy to determine the activity. The period (i.e., reaction time) determines the activity of the sulfur source at 160° C., and the reaction time should not be too long, otherwise the activity of sulfur source is too high, the selectivity decreases in the process of synthesizing perovskite core-shell quantum dots, and PbS impurities will be generated.

In an illustrated embodiment of the disclosure, the sulfur-octadecene solution is added by one-time injection. The reason why the disclosure adopts one-time injection is that the sulfur source of the disclosure has moderate reaction activity, and a large number of active precursors will not be generated rapidly by the one-time injection, therefore, self-nucleation of CdS is avoided, and the injection time has little influence on the reaction.

The core-shell quantum dots (Cd:CsPb(Br₁₋ₓClₓ)₃/CdS) prepared by the method of the disclosure adopt the method of injecting the CdS shell precursor (the sulfur-octadecene solution) at one time, thus simplifying the synthesis process. In addition, the perovskite/cadmium sulfide core-shell quantum dots (Cd:CsPb(Br₁₋ₓClₓ)₃/CdS) prepared by a thermal injection method have uniform quantum dot size and excellent deep blue light emitting performance.

In an illustrated embodiment of the disclosure, after the sulfur source is added into the first reaction solution for the second reaction, the preparation method further includes: obtaining a second reaction solution after the second reaction, cooling the second reaction solution to room temperature through an ice water bath to obtain a cooled reaction solution, and separating and purifying the cooled reaction solution by a high-speed centrifuge to obtain the core-shell quantum dots.

In a second aspect, an embodiment of the disclosure provides perovskite core-shell quantum dots (Cd:CsPb(Br₁₋ₓClₓ)₃/CdS), and the perovskite core-shell quantum dots are prepared by the preparation method described above.

In a third aspect, an embodiment of the disclosure provides an application method of the perovskite core-shell quantum dots (Cd:CsPb(Br₁₋ₓClₓ)₃/CdS) described above, and the application includes: applying the core-shell quantum dots in illumination or display.

Unless otherwise specified, the raw materials used in the embodiments of the disclosure can be obtained through commercial channels.

The sulfur-octadecene solution used in the embodiment of the disclosure is prepared by the following steps: adding 128.4 mg of S and 10 mL of octadecene into a three-necked flask with a capacity of 100 mL to obtain a mixture; using a vacuum pump to remove water and oxygen in the three-necked flask for 20 min at room temperature, then heating the mixture to 100° C., vacuum drying the mixture for 10 min; and introducing nitrogen gas into the three-necked flask for protection, heating the mixture to 160° C. and keeping the temperature of 160° C. for 2 h, and finally naturally cooling the three-necked flask to room temperature to thereby obtain the sulfur-octadecene solution with a concentration of 0.4 mmol/mL.

The cesium oleate solution used in the embodiment of the disclosure is prepared by the following steps: adding 250 mg of Cs₂CO₃, 1 mL of oleic acid and 10 mL of octadecene into a three-necked flask with a capacity of 100 mL to obtain a mixture, using a vacuum pump to remove water and oxygen in the three-necked flask for 30 min at room temperature, then heating the mixture to 120° C., vacuum drying the mixture for 30 min, then introducing nitrogen into the three-necked flask for protection, heating the mixture to 150° C. to fully react Cs₂CO₃ with the oleic acid to obtain a clear and transparent solution, and cooling the clear and transparent solution to 90° C. for standby use, to thereby obtain the cesium oleate solution.

The disclosure will be further described by the following embodiments.

### Embodiment 1 Preparation of Cd:CsPb(Cl/Br)₃ Core Quantum Dots (Abbreviated as Core Quantum Dots)

110.1 mg of PbBr₂, 36.7 mg of CdCl₂, 1.5 mL of oleic acid, 1.5 mL of oleylamine and 10 mL of octadecene are added into a three-necked flask with a capacity of 100 mL to obtain a first mixture, a vacuum pump is used to remove water and oxygen in the three-necked flask for 30 min at room temperature, the first mixture is heated to 120° C., and vacuum drying is performed on the first mixture for 30 min after all inorganic salts (i.e., PbBr₂ and CdCl₂) are completely dissolved in the octadecene. Then nitrogen is introduced into the three-necked flask for protection, and the first mixture is heated to a temperature of 160° C. After the temperature is stabilized, 0.6 mL of cesium oleate solution (a molar ratio Cs⁺ to Pb²⁺ is 0.28:1) is injected into the three-necked flask, and after 5 s of reaction, the three-necked flask is cooled in an ice water bath to obtain a perovskite core quantum dot solution.

The perovskite core quantum dot solution is centrifuged using a high-speed centrifuge at

a speed of 9500 revolutions per minute (rpm) for 5 min, to remove supernatant and disperse centrifugal solid precipitate in 6 mL of n-hexane to thereby obtain a second mixture, and then the second mixture is centrifuged using a high-speed centrifuge at a speed of 9500 rpm for 5 min to obtain supernatant and remove centrifugal solid precipitate. Methyl acetate is added into the obtained supernatant to obtain a third mixture, and a volume of the methyl acetate is equal to a volume of the obtained supernatant. The third mixture is centrifuged using a high-speed centrifuge at a speed of 8500 rpm for 5 min to remove supernatant and disperse centrifuged solid precipitate in 4 mL of n-hexane to thereby obtain a solution in which Cd:CsPb(Br₁₋ₓClₓ)₃ core quantum dots are dispersed.

### Embodiment 2 Preparation of Cd:CsPb(Br₁₋ₓClₓ)₃/CdS Core-Shell Quantum Dots (Abbreviated as Core-Shell Quantum Dots)

73.4 mg of PbBr₂, 27.2 mg of CdBr₂, 36.7 mg of CdCl₂, 1.5 mL of oleic acid, 1.5 mL of oleylamine and 10 mL of octadecene are added into a three-necked flask with a capacity of 100 mL to obtain a first mixture, a vacuum pump is used to remove water and oxygen in the three-necked flask for 30 min at room temperature, the first mixture is heated to 120° C., and vacuum drying is performed on the first mixture for 30 min after all inorganic salts are completely dissolved in the octadecene. Then nitrogen is introduced into the three-necked flask for protection, and the first mixture is heated to a temperature of 160° C. After the temperature is stable, 0.4 mL of cesium oleate solution (a molar ratio Cs⁺ to Pb²⁺ is 0.28:1) is injected into the three-necked flask. After 5 s of reaction, 0.5 mL of sulfur-octadecene solution is injected into a reaction solution at one time. After reaction is continued for 10 min, the three-necked flask is cooled in an ice water bath to obtain a perovskite/cadmium sulfide core-shell quantum dot solution.

The perovskite/cadmium sulfide core-shell quantum dot solution is centrifuged using a high-speed centrifuge at a speed of 9500 rpm for 5 min, to remove supernatant and disperse centrifugal solid precipitate in 6 mL of n-hexane to thereby obtain a second mixture, and then the second mixture is centrifuged using a high-speed centrifuge at a speed of 9500 rpm for 5 min, to obtain supernatant and remove centrifugal solid precipitate. Methyl acetate is added into the obtained supernatant to obtain a third mixture, and a volume of the methyl acetate is equal to a volume of the obtained supernatant. The third mixture is centrifuged using a high-speed centrifuge at a speed of 8500 rpm for 5 min, to remove supernatant and disperse centrifuged solid precipitate in 4 mL of n-hexane to thereby obtain a solution in which Cd:CsPb(Br₁₋ₓClₓ)₃/CdS core-shell quantum dots are dispersed.

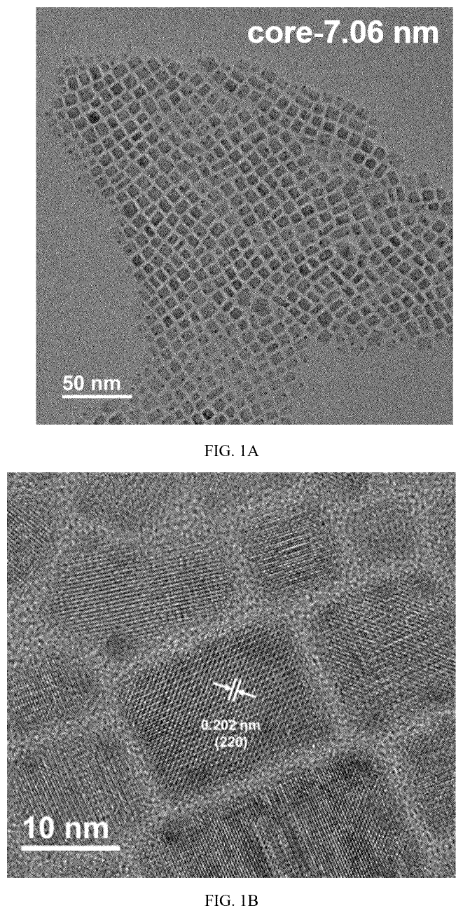

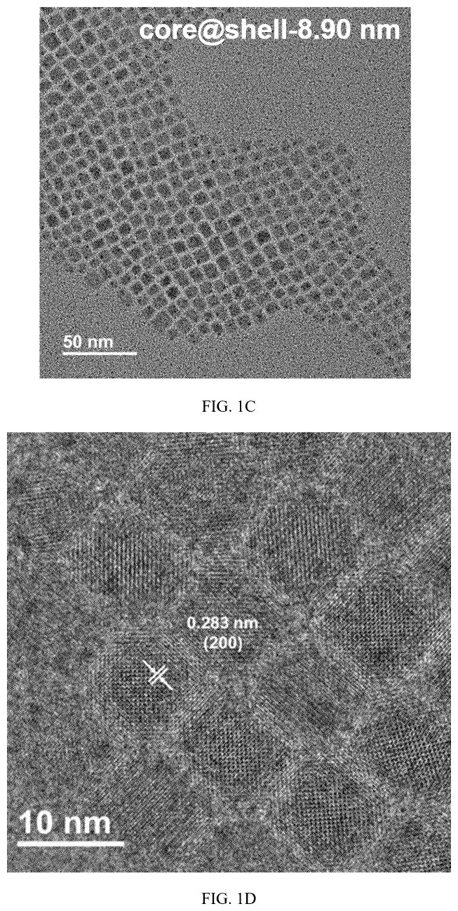

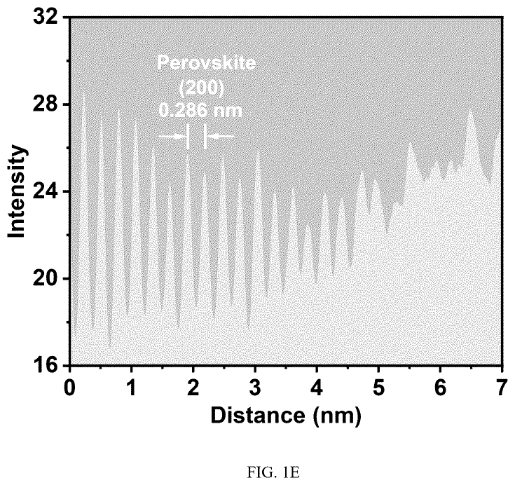

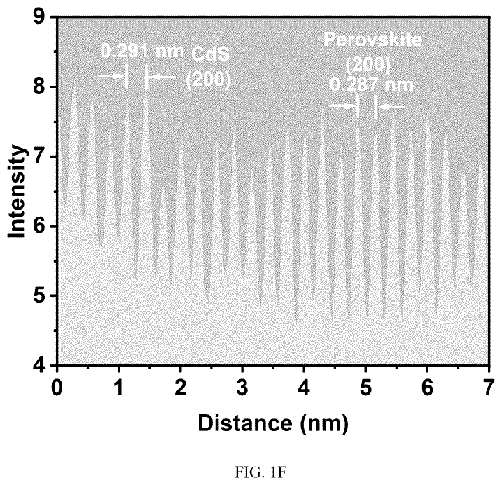

The morphology of the core quantum dots prepared in the embodiment 1 and the core-shell quantum dots prepared in the embodiment 2 are characterized by a TEM. As shown in FIG. 1A and FIG. 1C, an average particle size of core quantum dots (Cd:CsPb(Br₁₋ₓClₓ)₃ quantum dots) is 7.06 nm, and an average particle size of core-shell quantum dots (Cd:CsPb(Br₁₋ₓClₓ)₃/CdS core-shell quantum dots) is 8.90 nm. FIG. 1B and FIG. 1D illustrate an HRTEM image of core quantum dots and an HRTEM image of core-shell quantum dots, respectively. FIG. 1E illustrates a measurement result of a lattice spacing of the core quantum dots, and lattice stripes with a lattice spacing of 0.286 nm can be observed in the core quantum dots, which is a (200) crystal plane of perovskite. FIG. 1F illustrates a measurement result of a lattice spacing of the core-shell quantum dots, and shows that there is an obvious epitaxial lattice outside the perovskite with a lattice spacing of 0.291 nm, which is a (200) crystal plane of CdS, and the lattice spacing inside the quantum dots is 0.287 nm, which is a (200) crystal plane of perovskite.

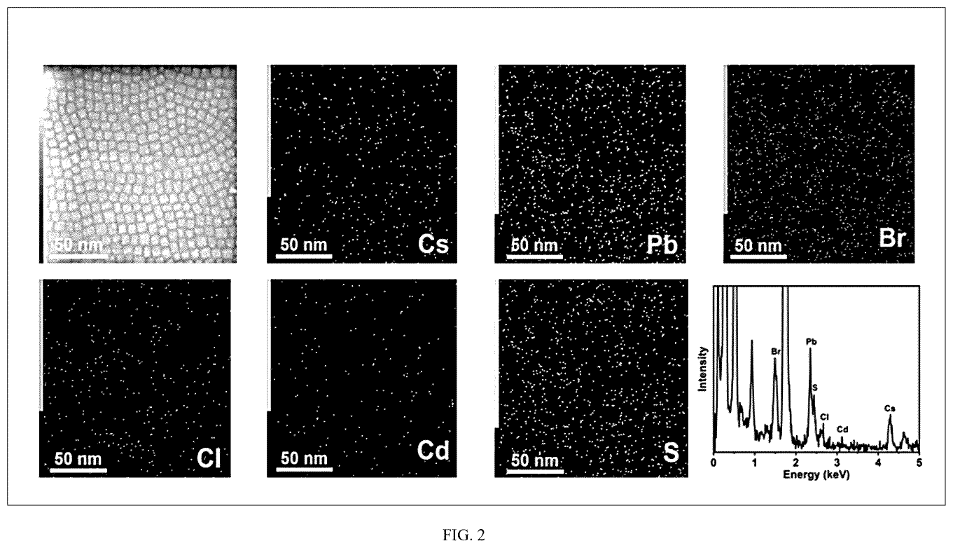

Element distribution of the core-shell quantum dots prepared in the embodiment 2 is characterized by energy-dispersive X-ray (EDX) of the TEM, and corresponding results are shown in FIG. 2. In an EDX diagram, it can be observed that the elements of Cs, Pb, Br, Cl, Cd and S are distributed in the perovskite core-shell quantum dots, and the X-ray characteristic peaks of Cs, Pb, Br, Cl, Cd and S are displayed in an EDX energy spectrum, which proves the existence of each of the elements.

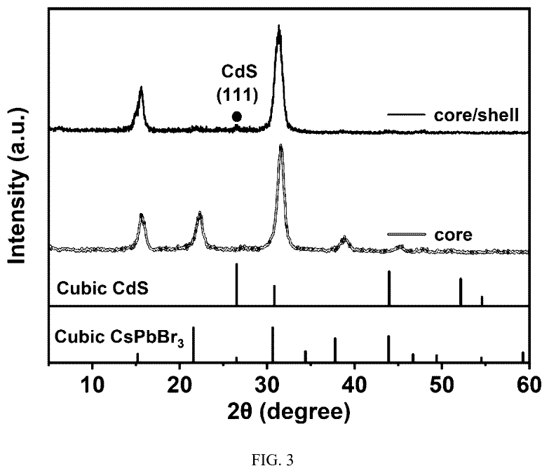

Crystal structures of the core quantum dots prepared in the embodiment 1 and the core-shell quantum dots prepared in the embodiment 2 are characterized by XRD, and corresponding results are shown in FIG. 3 (in the FIG. 3, core represents the core quantum dots, and core/shell represents core-shell quantum dots). An XRD curve of the core quantum dots in FIG. 3 shows diffraction peaks of (100), (110), (200), (211) and (220) planes of cubic perovskite, and the crystal lattice of perovskite is doped with elements Cl and Cd, which leads to the contraction of the crystal lattice and the displacement of the diffraction peaks to a higher angle direction. An XRD curve of the core-shell quantum dots mainly shows the diffraction peaks of (100) and (200) crystal planes of the cubic perovskite, and the diffraction peak of 26.5° belongs to a cubic CdS(111) crystal plane.

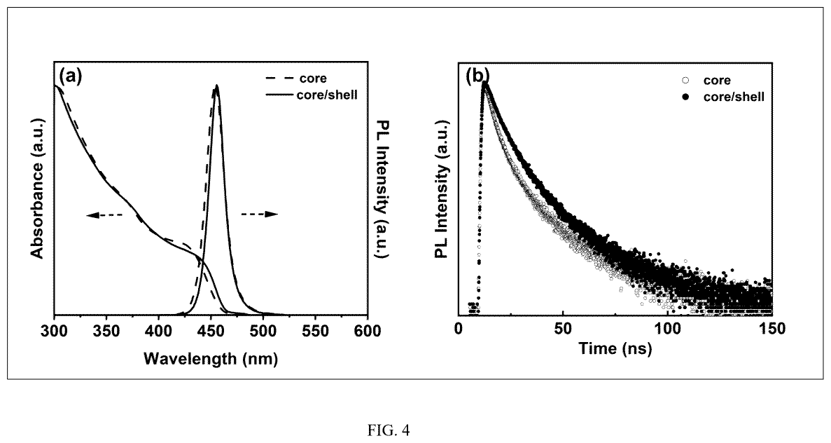

The core quantum dots prepared in the embodiment 1 and the core-shell quantum dots prepared in the embodiment 2 are optically characterized, and corresponding results are shown in FIG. 4 (in the FIG. 4, core represents the core quantum dots, and core/shell represents core-shell quantum dots). As shown in (a) of FIG. 4, a photoluminescence (PL) emission peak of the core quantum dots is 453 nm, a full width at half maximum (FWHM) of the core quantum dots is 20 nm, a PLQY of the core quantum dots is 14.65%, and a band edge of ultraviolet-visible (UV-Vis) absorption spectrum of the core quantum dots is 459 nm; a PL emission peak of the core-shell quantum dots is 455 nm, an FWHM of the core-shell quantum dots is 17 nm, a PLQY of the core-shell quantum dots is 66.07%, and a band edge of UV-Vis absorption spectrum of the core-shell quantum dots is 462 nm. As shown in (b) of FIG. 4, fluorescence lifetime τₐᵥₑ of the Cd:CsPb(Br₁₋ₓClₓ)₃/CdS core quantum dots is 5.83 ns, short lifetime τ₁ is 3.80 ns, a proportion A₁ corresponding to the short lifetime is 52.03%, long lifetime is 13.84 ns, and a proportion A₂ corresponding to the long lifetime is 47.97%; fluorescence lifetime τₐᵥₑ of Cd:CsPb(Br₁₋ₓClₓ)₃/CdS core-shell quantum dots is 8.02 ns, in which short life time τ₁ is 5.45 ns, a proportion A₁ corresponding to the short lifetime is 50.85%, and long lifetime is 15.63 ns, and a proportion A₂ corresponding to the long lifetime is 49.15%. This shows that the CdS shell reduces the defect state density of the perovskite quantum dots, obviously increases the fluorescence lifetime, reduces non-radiation recombination channels caused by defects and increases the radiation recombination channels.

The above-mentioned embodiments only describe the preferred implementations of the disclosure, and do not limit the scope of the disclosure. Under the premise of not departing from the design spirit of the disclosure, various modifications and improvements made by ordinary technicians in the field to the technical scheme of the disclosure shall fall within the protection of scope determined by the claims of the disclosure.

What is claimed is:

1. A preparation method of core-shell quantum dots, comprising:
mixing lead source, cadmium source, oleic acid, oleylamine and organic solvent to dissolve the lead source and the cadmium source in the organic solvent and thereby obtain first solution;
adding cesium oleate solution into the first solution for a first reaction to thereby obtain first reaction solution; and
adding sulfur source into the first reaction solution for a second reaction to thereby obtain the core-shell quantum dots, wherein the core-shell quantum dots are perovskite core-shell quantum dots (Cd:CsPb(Br₁₋ₓClₓ)₃/CdS).

2. The preparation method of the core-shell quantum dots as claimed in claim 1, wherein the lead source is lead bromide (PbBr₂), the cadmium source is a mixture of cadmium bromide (CdBr₂) and cadmium chloride (CdCl₂), and a molar ratio of CdBr₂ to CdCl₂ is 1:(1.5-2).

3. The preparation method of the core-shell quantum dots as claimed in claim 1, wherein a molar ratio of the lead source to the cadmium source is 2:3; a volume ratio of the oleic acid to the oleylamine is 1:1, and a molar volume ratio of the lead source to the oleic acid is 0.2 mmol:(1-1.5) mL.

4. The preparation method of the core-shell quantum dots as claimed in claim 1, wherein a molar ratio of Cs⁺ in the cesium oleate solution to Pb²⁺ in the lead source is 0.28:1.

5. The preparation method of the core-shell quantum dots as claimed in claim 1, wherein a temperature of the second reaction is 155-165° C., and a period of the second reaction is 5-10 min.

6. The preparation method of the core-shell quantum dots as claimed in claim 1, wherein the sulfur source is sulfur-octadecene solution, a concentration of the sulfur-octadecene solution is 0.4 mmol/mL, and a molar volume ratio of the lead source to the sulfur source is 2 mmol:5 mL.

7. The preparation method of the core-shell quantum dots as claimed in claim 6, wherein a preparation method of the sulfur-octadecene solution comprises:
mixing sulfur (S) and octadecene for a third reaction to thereby obtain the sulfur-octadecene solution.

8. The preparation method of the core-shell quantum dots as claimed in claim 7, wherein a temperature of the third reaction is 160° C., and a period of the third reaction is 1.2-2.5 h.

9. Perovskite core-shell quantum dots (Cd:CsPb(Br₁₋ₓClₓ)₃/CdS), wherein the perovskite core-shell quantum dots are prepared by the preparation method as claimed in claim 1.

10. An application method of the perovskite core-shell quantum dots (Cd:CsPb(Br₁₋ₓClₓ)₃/CdS) as claimed in claim 9, wherein the application method comprises: applying the core-shell quantum dots in illumination or display.
